(19) United States
(12) Patent Application Publication
(10) Pub. No.: US 2012/0247796 A1
(43) Pub. Date: Oct. 4, 2012

(54) CONTROL METHOD AND HAND-HELD POWER TOOL

(75) Inventors: Thomas Mueller, Klosterlechfeld (DE); Benno Verhaag, Fuerstenfeldbruck (DE); Jens Imaschewski, Muenchen (DE)

(73) Assignee: Hilti Aktiengesellschaft, Schaan (LI)

(21) Appl. No.: 13/434,328

(22) Filed: Mar. 29, 2012

(30) Foreign Application Priority Data
Mar. 30, 2011 (DE) DE 102011006385.4

(51) Int. Cl. B25F 5/00

(52) U.S. Cl. 173/1; 173/2

(57) ABSTRACT

The hand-held power tool has a tool socket to hold a tool. A motor is coupled to the tool socket in order to drive the tool socket. The motor is arranged in a housing. The housing has a holder that is provided with a mechanical lock for detachably coupling a battery pack, and with a power connection for electrically connecting the battery pack to the motor. A communication interface serves to transmit properties of the battery pack to a motor control unit. The motor control unit includes a soft start that accelerates the speed of the motor from a standstill to a target speed at a given rate, whereby the motor control unit controls the rate as a function of a property of the battery pack transmitted by the battery pack.

This claims the benefit of German Patent Application DE 10 2011 006 385.4, filed Mar. 30, 2011 and hereby incorporated by reference herein.

The invention relates to a control method for a battery-operated hand-held power tool and to a battery-operated hand-held power tool, especially to an electric hand-held power tool such as, for example, an electric screwdriver.

### SUMMARY OF THE INVENTION

The present invention provides a battery-operated hand-held power tool having a tool socket to hold a tool. A motor is coupled to the tool socket in order to drive said tool socket. The motor is arranged in a housing. The housing has a holder that is provided with a mechanical lock for detachably coupling a battery pack, and with a power connection for electrically connecting the battery pack to the motor. A communication interface serves to transmit properties of the battery pack to a motor control unit. The motor control unit comprises a soft start that accelerates the speed of the motor from a standstill to a target speed at a given rate, whereby the motor control unit controls the rate as a function of a property of the battery pack transmitted by the battery pack.

The present invention provides a control method including the following steps: requesting properties of the battery pack that has been coupled to the hand-held power tool, setting a rate for accelerating the motor as a function of the transmitted properties of the battery pack, and accelerating the motor at the set rate when the trigger is actuated.

The transmitted property of the battery pack is especially a measure of the internal resistance of the battery pack. The rate can be set at a first value when the internal resistance falls below a threshold value, and at a second value when the internal resistance exceeds the threshold value. The second value is higher than the first value. The motor control unit accelerates the motor to the target speed in a shorter period of time when the transmitted internal resistance is less than the threshold value. Otherwise, the motor slows down and correspondingly accelerates to the target speed over a longer period of time. The measure of the internal resistance can be, for instance, the presence of a parallel connection or of a series connection and/or the type of battery cells of the battery pack.

The battery pack for the hand-held power tool can contain a data memory in which the internal resistance of the battery pack is stored. The internal resistance is determined for a selected temperature, e.g. room temperature. A refinement of the hand-held power tool or of the control method makes use of a temperature sensor in order to measure the ambient temperature or the temperature of the battery pack. The measured temperature is used to compensate for temperature dependences of the internal resistance of the battery pack. The hand-held power tool can set the rate for accelerating the motor as a function of the temperature. In particular, the rate is reduced whenever a temperature below the freezing point is measured.

In one embodiment, the hand-held power tool monitors the voltage that is present at the power connection during the acceleration of the motor, whereby the rate is reduced if the voltage that is present falls below a first threshold value. In particular, the current uptake from the battery pack can be interrupted when the voltage that is present at the power connection falls below a second threshold value that is lower than the first threshold value. The battery pack can have an autonomous protection mechanism that prevents an overload of the battery pack. The protection mechanism monitors, for example, the voltage of every single battery cell. As soon as the voltage of one of the battery cells falls below the second threshold value of, for instance, 2.5 V, the battery pack is immediately disconnected from the hand-held power tool. The brief high current consumption during the acceleration of the motor could bring about the occurrence of a drop or of the second threshold value. In anticipation, the motor control unit reduces the rate of acceleration in order to prevent the motor from switching off completely.

In one embodiment, the acceleration of the motor is set by a pulse width modulation. The duty cycle of the pulse width modulation is specified by the dependences of the rate that has been set.

### BRIEF DESCRIPTION OF THE DRAWING

The description below explains the invention on the basis of figures and embodiments provided by way of examples. The figures show the following:

FIG. 1 an electric screwdriver.

### DETAILED DESCRIPTION

Unless otherwise indicated, the same or functionally equivalent elements are designated by the same reference numerals in the figures.

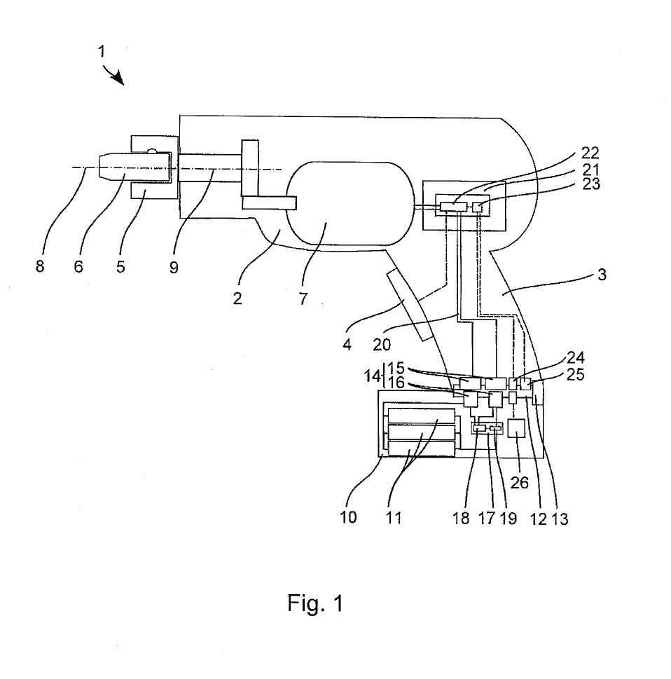

FIG. 1 shows an electric screwdriver 1 as an example of a hand-held power tool. The electric screwdriver 1 has a housing 2 with a handle 3 by means of which a user can hold and guide the electric screwdriver 1. A trigger 4 on the handle 3 allows the user to put the electric screwdriver 1 into operation. Typically, the user has to continuously depress the trigger 4 in order to keep the electric screwdriver 1 in operation.

The electric screwdriver 1 has a tool socket 5 into which the user can insert a screwdriver bit 6. When the trigger 4 is actuated, an electric motor 7 rotates the tool socket 5 around it axis 8. The electric motor 7 is coupled to the tool socket 5 via a spindle 9 and, if applicable, via additional components of a drive train such as, for example, coupling, gear.

The power of the electric motor 7 comes from the battery pack 10. The battery pack 10 has a plurality of secondary battery cells 11 that make use, for example, of lithium-based chemistry.

The housing 2 has a holder 12 for the battery pack 10 that, by way of example, is provided at one end of the handle 3. The holder 12 can have rails with an L-shaped profile into which complementary rails on the battery pack 10 can be slid. A detachable lock 13 prevents the battery pack 10 from falling out of the holder 12. A power connection 14 of the hand-held power tool 1 is arranged in the holder 12. The power connection 14 comprises, for example, two or more electric contacts 15. The battery pack 10 has contacts 16 that are complementary to the power connection 14 of the hand-held power tool 1, and these contacts are electrically contacted when a battery pack 10 is inserted into the holder 12.

The battery pack 10 can have an autonomous protection mechanism 17. The protection mechanism 17 comprises, for instance, a voltage sensor 18 that monitors the voltages of the individual battery cells 11. If the protection mechanism 17 detects that the voltage of one of the battery cells 11 has dropped below a critical threshold value, the current output of the battery pack 10 is interrupted. The critical threshold value is selected in such a way as to prevent a non-reversible discharge of the battery cells 11. The threshold value for Li-ion chemistry-based battery cells 11 is, for example, about 2.5 V, especially at room temperature. The battery pack 10 can interrupt a current path 20 between the battery pack 10 and the electric motor 7, for example, by means of a switch 19, e.g. an FET, located in the battery pack 10 or in the hand-held power tool 1. The reversible protection mechanism 17 and the associated switch 19 are independent of other systems. This is especially the case when the switch 19 is arranged in the battery pack 10 and when all the power supply to the hand-held power tool 1 through the battery pack 10 is interrupted.

The hand-held power tool 1 can be operated at a regulated speed. The speed can be set by a user or it can already be preset unchangeably for the hand-held power tool 1. A motor control unit 21 with one or more switch elements 22 sets a power uptake of the hand-held power tool 1 in order to regulate the speed to the target value. One embodiment of a hand-held power tool 1 does not provide for a regulated speed, but rather, the speed is limited by a maximum power uptake of the electric motor 7, for example, by the nominal power of the electric motor 7 or by a nominal maximum power output of the battery pack 10.

The motor control unit 21 comprises a module for a soft start 23. The soft start 23 is activated by actuating the trigger 4. The soft start 23 limits the mean power uptake of the electric motor 7. For example, a switch element in the current path to the electric motor 7 can be actuated by means of pulse width modulation. The duty cycle of the pulse width modulation is specified by the soft start 23 on the basis of the desired average power uptake. The soft start 23 specifies the period of time during which the electric motor 7 is accelerated to the target speed. The torque that can be generated by the electric motor 7 as well as the acceleration value (acceleration rate) that is established due to the load that is present, are limited to a set rate by the soft start 23. A soon as the electric motor 7 has reached the target speed, the soft start 23 is deactivated and, if applicable, the speed is regulated to the target speed. As an alternative, the soft start 23 can be terminated after a defined period of time.

The motor control unit 21 communicates with the battery pack 10 in order to ascertain its properties. A communication interface 24 of the motor control unit 21 queries, among other things, the internal resistance of the battery pack 10. The battery pack 10 has, for instance, an information memory in which the internal resistance of the battery pack 10 is stored. The internal resistance can be stored in Ohm or another unit of measurement. As an alternative, the inner resistance can be stored implicitly by the indication as to whether battery cells are present in a parallel circuit and, if applicable, how many parallel rows of battery cells 11 are present. The battery pack 10 can also transmit the type of employed battery cells 11 and, on the basis of this information, the soft start 23 sets the rate.

The communication interface 24 is preferably an electric communication interface whose receiving unit receives information from the battery pack 10 transmitted from a memory module 26 as electric signals. As an alternative, the communication interface 24 can comprise a detector that acquires units of information passively provided by the battery pack 10. For example, the units of information can be present in the battery pack 10 in the form of a barcode, mechanical encoding, etc.

The motor control unit 21 sets the soft start 23 as a function of the internal resistance transmitted by the battery pack 10. The motor control unit 21 can compare the transmitted internal resistance to a threshold value. If the internal resistance exceeds the threshold value, a lower rate is selected for the acceleration. The lower rate can also be set if the battery pack 10 transmits information indicating a pure series connection of the battery cells 11. A duty cycle of the pulse width modulation can be initially set, for example, in the range between 40% and 60%, and continuously increased to 100% by the soft start 23. The rate defines the duration for which the duty cycle rises to 100%. If information indicating a lower internal resistance or a parallel circuit of the battery cells 11 is transmitted, then the motor 7 can be accelerated markedly. Moreover, the initial value for the duty cycle can be set at a value between 60% and 75%. A low rate for the first case can, for example, accelerate the electric motor 7 within 0.6 seconds, while a high rate for the second case can, for example, be twice as high as the low rate, in other words, it can accelerate the electric motor 7 to the target speed within 0.3 seconds.

A refinement provides for a temperature sensor 25 that detects the temperature of the battery pack 10. If the temperature falls below a threshold value, the rate for the acceleration is reduced. For example, the rate can be reduced by 10% for each 5° C. that the temperature is less than 10° C. By the same token, for instance, the starting value for the duty cycle can be lowered to 20%, for example, if the temperature is below the freezing point.

What is claimed is:

1. A control method for a hand-held power tool comprising a tool socket to hold a tool, a motor coupled to the tool socket to drive the tool socket, a housing, the motor being arranged in the housing, a holder on the housing provided with a mechanical lock for detachably coupling a battery pack and with a power connection for electrically connecting the battery pack to the motor, a communication interface for transmitting properties of the battery pack to a motor control unit, and a trigger operable by a user to activate the hand-held power tool, the method comprising the steps of:
requesting properties of the battery pack coupled to the hand-held power tool;
setting a rate for accelerating the motor as a function of transmitted properties of the battery pack; and
accelerating the motor at the set rate when the trigger is actuated.

2. The control method as recited in claim 1 wherein the properties are a measure of an internal resistance of the battery pack.

3. The control method as recited in claim 2 wherein a first value is settable for the rate when the internal resistance falls below a threshold value, and a second value, which is higher than the first value, is settable when the internal resistance exceeds the threshold value.

4. The control method as recited in claim 2 wherein the measure of the internal resistance indicates a presence of at least one of a pure series connection, a parallel connection of battery cells and a type of the battery cells.

5. The control method as recited in claim 1 wherein a temperature of the battery pack is determined, and the rate is set as a function of the temperature.

6. The control method as recited in claim 1 wherein the hand-held power tool monitors a voltage present at the power connection during the acceleration of the motor, the rate being reduced if the voltage that is present falls below a threshold value.

7. The control method as recited in claim 6 wherein a current uptake from the battery pack is interrupted when the voltage present at the power connection falls below another threshold value that is lower than the threshold value.

8. The control method as recited in claim 1 wherein the motor control unit sets a current flow in the motor by means of a pulse width modulation, and the duty cycle is changed as a function of the rate.

9. A hand-held power tool comprising:
a tool socket to hold a tool;
a motor coupled to the tool socket to drive the tool socket;
a housing, the motor being arranged in the housing;
a holder on the housing having a mechanical lock for detachably coupling a battery pack and having a power connection for electrically connecting the battery pack to the motor;
a motor control unit;
a communication interface for transmitting properties of the battery pack to the motor control unit, the motor control unit including a start accelerating the speed of the motor from a standstill to a target speed at a given rate, the motor control unit controlling the rate as a function of a property of the battery pack transmitted by the battery pack.

10. The hand-held power tool as recited in claim 9 wherein the battery pack has an information memory, a unit of information containing the measure of the internal resistance of the battery pack being stored in the information memory, the communication interface for transmitting the unit of information to the hand-held power tool.
